(19) United States
(12) Patent Application Publication
(10) Pub. No.: US 2023/0409102 A1
(43) Pub. Date: Dec. 21, 2023

(54) LOW-POWER KEYWORD SPOTTING SYSTEM

(71) Applicant: FLUENT.AI INC., Montreal (CA)

(72) Inventors: Sam MYER, Montreal (CA); Vikrant TOMAR, Montreal (CA)

(21) Appl. No.: 18/242,202

(22) Filed: Sep. 5, 2023

Related U.S. Application Data
(63) Continuation of application No. 16/958,401, filed on Jun. 26, 2020, now abandoned.
(60) Provisional application No. 62/611,794, filed on Dec. 29, 2017.

(51) Int. Cl. G06F 1/3231; G06F 1/3296; G06F 3/16; G06N 3/084; G10L 15/16; G10L 25/30; G06N 3/045

(52) U.S. Cl. CPC G06F 1/3231; G06F 1/3296; G06F 3/167; G06N 3/084; G10L 15/16; G10L 25/30; G06N 3/045; G10L 2015/088

(57) ABSTRACT

A system and method of performing low-power keyword detection is provided. An acoustic signal is obtained comprising speech by an electronic device. The acoustic signal is preprocessed by transforming the acoustic signal to a frequency domain representation. The frequency domain representation is divided into a plurality of frequency bands. The plurality of frequency bands is provided to a neural network. At least one of a plurality of keywords or absence of any of the plurality of keywords is predicted. The acoustic signal can then be provided for additional processing by a higher power processing core.

### CROSS-REFERENCE TO RELATED APPLICATIONS

This application is a continuation of U.S. application Ser. No. 16/958,401, filed on Jun. 26, 2020, which in turn is a national phase filing of international application no. PCT/CA2018/051681 filed on Dec. 28, 2018, which in turn claims priority to United Stated Provisional Application No. 62/611,794 filed Dec. 29, 2017. The entirety of all three of these applications is hereby incorporated by reference for all purposes.

### TECHNICAL FIELD

The present disclosure relates to methods and devices for recognizing spoken keywords in acoustic signals. The invention describes a low-power system that can be used to recognize one or more spoken keywords in a continuous audio stream.

### BACKGROUND

One application for keyword spotting is as wakeword, keyword or trigger-word for hands-free operations on a voice interface device such as smart speakers and smart assistants. In such scenarios, the user speaks a predefined keyword to “wake-up” the device before speaking a complete command or query to the device.

Large vocabulary speech recognition is a compute-intensive task, whereas a low-resource keyword spotting algorithm allows the device to operate at low-power by using a simpler model that only detects whether a phrase or small set of phrases are spoken. Once a wake-word has been detected, then the more complex large vocabulary model is used to decode the user query which follows.

Prior art technologies have proposed keyword spotting models with a variety of architectures such as recurrent neural networks (RNNs) combined with convolution layers, or Grid-LSTM RNNs capable of learning sequences in both the time and frequency dimensions. However, these architectures have high computational complexity and require a large amount of training data to work well.

Many of the new smart devices with a voice user-interface uses small microprocessors and many are even battery powered. Accordingly, systems and methods with small computational footprint and power requirement for designing an optimal keyword spotting remains highly desirable.

### SUMMARY

In accordance with and aspect of the present disclosure there is provided a method for keyword spotting comprising: obtaining acoustic signal comprising speech; providing an acoustic signal representation of the acoustic signal to a neural network; and predicting from the neural network a presence of at least one of a plurality of keywords or absence of any of the plurality of keywords in the acoustic signal.

In a further aspect of the method, the acoustic signal representation comprises a feature domain representation obtained by preprocessing the acoustic signal.

In a further aspect of the method, the feature domain representation comprises one of log-Mel filterbank (FBANK), Mel-filtered cepstrum coefficients MFCC, and Perceptual Linear Prediction PLP.

In a further aspect of the method, the acoustic signal representation is a waveform representation.

In a further aspect of the method, the neural network is a time delayed neural network (TDNN) that produces a sequence of keyword posteriors.

In a further aspect of the method, smoothing is applied to the keyword posteriors.

In a further aspect of the method, predicting the presence or absence of keywords comprises determining if a posterior value for any of the plurality of keywords exceeds a threshold value, and if the posterior value of a respective keyword exceeds the threshold value predicting the presence of the respective keyword in the audio signal.

In a further aspect of the method, a plurality of different threshold values are used for the plurality of keywords.

In a further aspect of the method, the TDNN uses one or more sets of layers to learn phone and keyword targets.

In a further aspect of the method, a first set of layers is initialized by using transfer learning on a related large vocabulary speech recognition task.

In a further aspect of the method, a method for reducing a number of multiplications using dynamic programming is used.

In a further aspect of the method, a total number of multiplications is reduced using frame skipping.

In a further aspect of the method, a voice activity detection (VAD) system is used to minimize computation by the TDNN network, wherein the VAD system only sends the audio signal representation to the TDNN when speech is detected in the background.

In a further aspect, the method further comprises recording the user query which follows keyword detection and recording it for further decoding.

In a further aspect of the method, the start and end times of the keyword are found in the audio stream.

In a further aspect of the method, a second neural network is used for second stage decoding, comprising of one or more of: a bidirectional GRU RNN model to produce a phone posteriorgram; a histogram of acoustic correlations (HAC) to produce a fixed-length vector from the phone posteriorgram; and a fully-connected network to produce keyword probabilities from the fixed-length vector.

In a further aspect of the method, training data for the neural network is produced by concatenating recordings of commands and user queries at different volume levels and mixing with different types of noises.

In a further aspect of the method, unrelated conversational data is included in the training data.

In a further aspect of the method, upon predicting from the neural network a presence of at least one of the plurality of keywords in the acoustic signal by a first processing core, a second processing core is awoken from a sleep state to perform further processing on the acoustic signal.

In a further aspect of the method, the second processing core verifies the presence of at least one of the plurality of keywords in the acoustic before performing further processing of the acoustic signal to determine one or more commands within the acoustic signal.

In a further aspect of the method, the first core is a low-power core and the second-core is a high-power core.

In accordance with another aspect of the present disclosure there is further provided a system comprising: a microphone; a memory storing instructions; and a processor coupled to the microphone and memory, the processor executing the instructions, which when executed configure the system to: obtain acoustic signal comprising speech; provide an acoustic signal representation of the acoustic signal to a neural network; and predict from the neural network a presence of at least one of a plurality of keywords or absence of any of the plurality of keywords in the acoustic signal.

In a further aspect of the system, the acoustic signal representation comprises a feature domain representation obtained by preprocessing the acoustic signal.

In a further aspect of the system, the feature domain representation comprises one of log-Mel filterbank (FBANK), Mel-filtered cepstrum coefficients MFCC, and Perceptual Linear Prediction PLP.

In a further aspect of the system, the acoustic signal representation is a waveform representation.

In a further aspect of the system, the neural network is a time delayed neural network (TDNN) that produces a sequence of keyword posteriors.

In a further aspect of the system, smoothing is applied to the keyword posteriors.

In a further aspect of the system, predicting the presence or absence of keywords comprises determining if a posterior value for any of the plurality of keywords exceeds a threshold value, and if the posterior value of a respective keyword exceeds the threshold value predicting the presence of the respective keyword in the audio signal.

In a further aspect of the system, a plurality of different threshold values are used for the plurality of keywords.

In a further aspect of the system, the TDNN uses one or more sets of layers to learn phone and keyword targets.

In a further aspect of the system, a first set of layers is initialized by using transfer learning on a related large vocabulary speech recognition task.

In a further aspect of the system, a method for reducing a number of multiplications using dynamic programming is used.

In a further aspect of the system, a total number of multiplications is reduced using frame skipping.

In a further aspect of the system, a voice activity detection (VAD) system is used to minimize computation by the TDNN network, wherein the VAD system only sends the audio signal representation to the TDNN when speech is detected in the background.

In a further aspect of the system, the instructions which when executed further configure the system to record the user query which follows keyword detection and recording it for further decoding.

In a further aspect of the system, the start and end times of the keyword are found in the audio stream.

In a further aspect of the system, a second neural network is used for second stage decoding, comprising of one or more of: a bidirectional GRU RNN model to produce a phone posteriorgram; a histogram of acoustic correlations (HAC) to produce a fixed-length vector from the phone posteriorgram; and a fully-connected network to produce keyword probabilities from the fixed-length vector.

In a further aspect of the system, training data for the neural network is produced by concatenating recordings of commands and user queries at different volume levels and mixing with different types of noises.

In a further aspect of the system, unrelated conversational data is included in the training data.

In a further aspect of the system, the processor further comprises a first core and a second core, wherein the first core is a low-power processing core and the second core is a high-power processing core, when the first core determine the presence of at least one of a plurality of keywords in the acoustic signal the acoustic signal is provided to the second core for further processing.

In a further aspect of the system, the further processing comprises performing keyword verification.

In a further aspect of the system, the processor operates in a lower power state until the presence of at least one of a plurality of keywords in the acoustic signal the acoustic signal and transitions to a high power state for performing further processing of the acoustic signal.

### BRIEF DESCRIPTION OF THE DRAWINGS

Further features and advantages of the present disclosure will become apparent from the following detailed description, taken in combination with the appended drawings, in which:

FIG. 1 depicts a low-power wakeword spotting system;

FIG. 2 depicts training of a low-power wakeword spotting system;

FIG. 3 depicts an on device second stage wakeword spotting system;

FIGS. 4a and 4b depict ROC curves comparing the disclosed method with related art;

FIGS. 5a and 5b depict ROC curves showing the effects of frame skipping;

FIG. 6 depicts a method of low-power wakeword spotting which is performed on an electronic device

FIG. 7 illustrates a computing device for implementing low-power wakeword spotting system; and

FIG. 8 depicts an ROC curve showing performance with multiple command words

It will be noted that throughout the appended drawings, like features are identified by like reference numerals.

### DETAILED DESCRIPTION

In accordance with the present disclosure there is provided a method for keyword spotting comprising: obtaining acoustic signal comprising speech; providing an acoustic signal representation of the acoustic signal to a neural network; and predicting from the neural network a presence of at least one of a plurality of keywords or absence of any of the plurality of keywords in the acoustic signal.

In a further embodiment of the method, the acoustic signal representation comprises a feature domain representation obtained by preprocessing the acoustic signal.

In a further embodiment of the method, the feature domain representation comprises one of log-Mel filterbank (FBANK), Mel-filtered cepstrum coefficients MFCC, and Perceptual Linear Prediction PLP.

In a further embodiment of the method, the acoustic signal representation is a waveform representation.

In a further embodiment of the method, the neural network is a time delayed neural network (TDNN) that produces a sequence of keyword posteriors.

In a further embodiment of the method, smoothing is applied to the keyword posteriors.

In a further embodiment of the method, predicting the presence or absence of keywords comprises determining if a posterior value for any of the plurality of keywords exceeds a threshold value, and if the posterior value of a respective keyword exceeds the threshold value predicting the presence of the respective keyword in the audio signal.

In a further embodiment of the method, a plurality of different threshold values are used for the plurality of keywords.

In a further embodiment of the method, the TDNN uses one or more sets of layers to learn phone and keyword targets.

In a further embodiment of the method, a first set of layers is initialized by using transfer learning on a related large vocabulary speech recognition task.

In a further embodiment of the method, a method for reducing a number of multiplications using dynamic programming is used.

In a further embodiment of the method, a total number of multiplications is reduced using frame skipping.

In a further embodiment of the method, a voice activity detection (VAD) system is used to minimize computation by the TDNN network, wherein the VAD system only sends the audio signal representation to the TDNN when speech is detected in the background.

In a further embodiment, the method further comprises recording the user query which follows keyword detection and recording it for further decoding.

In a further embodiment of the method, the start and end times of the keyword are found in the audio stream.

In a further embodiment of the method, a second neural network is used for second stage decoding, comprising of one or more of: a bidirectional GRU RNN model to produce a phone posteriorgram; a histogram of acoustic correlations (HAC) to produce a fixed-length vector from the phone posteriorgram; and a fully-connected network to produce keyword probabilities from the fixed-length vector.

In a further embodiment of the method, training data for the neural network is produced by concatenating recordings of commands and user queries at different volume levels and mixing with different types of noises.

In a further embodiment of the method, unrelated conversational data is included in the training data.

In a further embodiment of the method, upon predicting from the neural network a presence of at least one of the plurality of keywords in the acoustic signal by a first processing core, a second processing core is awoken from a sleep state to perform further processing on the acoustic signal.

In a further embodiment of the method, the second processing core verifies the presence of at least one of the plurality of keywords in the acoustic before performing further processing of the acoustic signal to determine one or more commands within the acoustic signal.

In a further embodiment of the method, the first core is a low-power core and the second-core is a high-power core.

In accordance with the present disclosure there is further provided a system comprising: a microphone; a memory storing instructions; and a processor coupled to the microphone and memory, the processor executing the instructions, which when executed configure the system to: obtain acoustic signal comprising speech; provide an acoustic signal representation of the acoustic signal to a neural network; and predict from the neural network a presence of at least one of a plurality of keywords or absence of any of the plurality of keywords in the acoustic signal.

In a further embodiment of the system, the acoustic signal representation comprises a feature domain representation obtained by preprocessing the acoustic signal.

In a further embodiment of the system, the feature domain representation comprises one of log-Mel filterbank (FBANK), Mel-filtered cepstrum coefficients MFCC, and Perceptual Linear Prediction PLP.

In a further embodiment of the system, the acoustic signal representation is a waveform representation.

In a further embodiment of the system, the neural network is a time delayed neural network (TDNN) that produces a sequence of keyword posteriors.

In a further embodiment of the system, smoothing is applied to the keyword posteriors.

In a further embodiment of the system, predicting the presence or absence of keywords comprises determining if a posterior value for any of the plurality of keywords exceeds a threshold value, and if the posterior value of a respective keyword exceeds the threshold value predicting the presence of the respective keyword in the audio signal.

In a further embodiment of the system, a plurality of different threshold values are used for the plurality of keywords.

In a further embodiment of the system, the TDNN uses one or more sets of layers to learn phone and keyword targets.

In a further embodiment of the system, a first set of layers is initialized by using transfer learning on a related large vocabulary speech recognition task.

In a further embodiment of the system, a method for reducing a number of multiplications using dynamic programming is used.

In a further embodiment of the system, a total number of multiplications is reduced using frame skipping.

In a further embodiment of the system, a voice activity detection (VAD) system is used to minimize computation by the TDNN network, wherein the VAD system only sends the audio signal representation to the TDNN when speech is detected in the background.

In a further embodiment of the system, the instructions which when executed further configure the system to record the user query which follows keyword detection and recording it for further decoding.

In a further embodiment of the system, the start and end times of the keyword are found in the audio stream.

In a further embodiment of the system, a second neural network is used for second stage decoding, comprising of one or more of: a bidirectional GRU RNN model to produce a phone posteriorgram; a histogram of acoustic correlations (HAC) to produce a fixed-length vector from the phone posteriorgram; and a fully-connected network to produce keyword probabilities from the fixed-length vector.

In a further embodiment of the system, training data for the neural network is produced by concatenating recordings of commands and user queries at different volume levels and mixing with different types of noises.

In a further embodiment of the system, unrelated conversational data is included in the training data.

In a further embodiment of the system, the processor further comprises a first core and a second core, wherein the first core is a low-power processing core and the second core is a high-power processing core, when the first core determine the presence of at least one of a plurality of keywords in the acoustic signal the acoustic signal is provided to the second core for further processing.

In a further embodiment of the system, the further processing comprises performing keyword verification.

In a further embodiment of the system, the processor operates in a lower power state until the presence of at least one of a plurality of keywords in the acoustic signal the acoustic signal and transitions to a high power state for performing further processing of the acoustic signal.

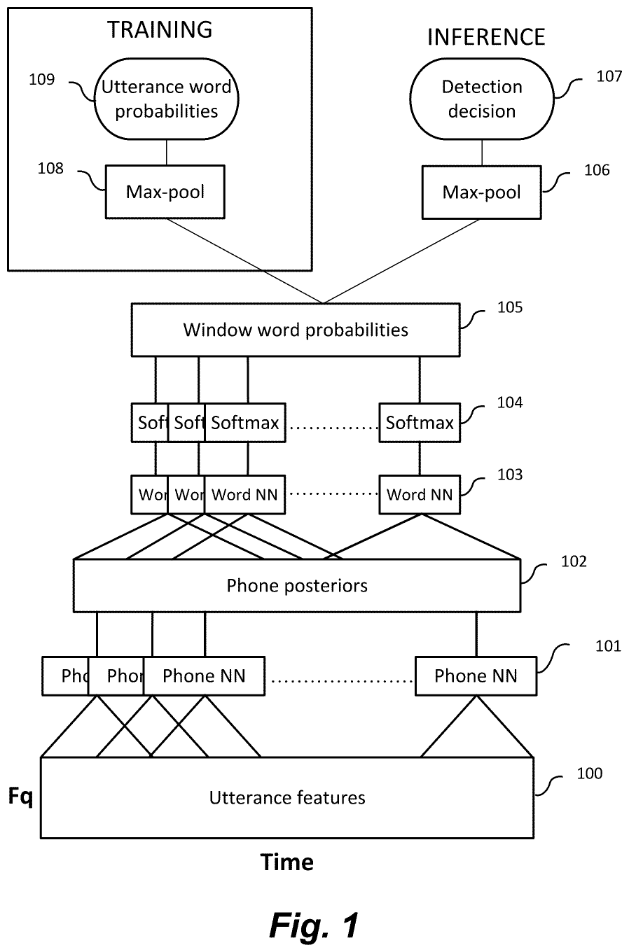

Embodiments are described below, by way of example only, with reference to FIGS. 1-8.

Prior art technologies have used time-delay neural networks for keyword spotting. For example, work in Ming Sun et al., “Compressed time delay neural network for small-footprint keyword spotting,” Interspeech, pp. 3607-3611, 2017, uses a time-delay neural network combined with a hidden Markov model (HMM) for recognizing the keyword, such as “Alexa”. A singular value decomposition (SVD) has also been used based on bottleneck layers to reduce the model size. Such methods require keyword training data with phone labels in order to work. The system and method described herein may perform low-powered keyword spotting using a multi-stage time-delay neural network architecture that doesn't require a separate HMM model or phone-labeled keyword training data.

In a time-delay neural network, different layers or sets of layers act on different time scales. Lower layers look at smaller time scales and produce higher level features with smaller dimensions to be sent to higher layers. This allows the architecture to look at a large time window, while reducing an amount of computations required. During training, the input features are repeatedly shifted in time and fed to the model. This introduces time-shift invariance and can operate on a sequence of any duration.

There are several factors to be considered when designing an effective keyword detection system. Both false positives and false negatives must be kept at a very low rate to provide an acceptable user experience. The amount of computation required by the model should be minimized in order to reduce power drain. Latency must also be kept low to keep the user interface responsive. A neural network architecture is disclosed which provides a method of computation which reduces the number of computations while maintaining an acceptable level of accuracy.

Referring to FIG. 1, a TDNN comprises of two sets of layers. The two sets of layers can be seen as two different neural networks, although may be provided as a single neural network. The first set of layers takes a set of speech feature vectors in one instance as input and produces phone posterior probabilities as output. Some examples of speech feature vectors include log-Mel filterbank (FBANK) features, Mel-filtered cepstrum coefficients (MFCC) features, and Perceptual Linear Prediction (PLP) features but many other forms are possible. It is also possible to train and use a neural network directly with waveform data avoiding performing any feature extraction. The low-powered keyword spotting system described herein is applicable to speech feature vectors as well as to direct waveform data. The first set of layers is referred to as the phone-NN 101. The second set of layers takes phone posteriors as input and produces word posteriors. This is referred to as the word-NN 103. While other approaches can learn on phone labels only, or on word labels only, this approach can learn using either.

In this example implementation the input audio data is transformed in to the frequency domain and frequency-band features are extracted from the audio for the feature windows 100. The filterbank features are normalized so that they have approximately zero mean and unit variance.

The phone-NN 101 outputs a vector which represents a posterior probability distribution over different phones 102. These phone posteriors are then used as input for the next set of layers. In an example implementation, 42 posteriors were used—3 representing silence or noise and 39 representing different phones.

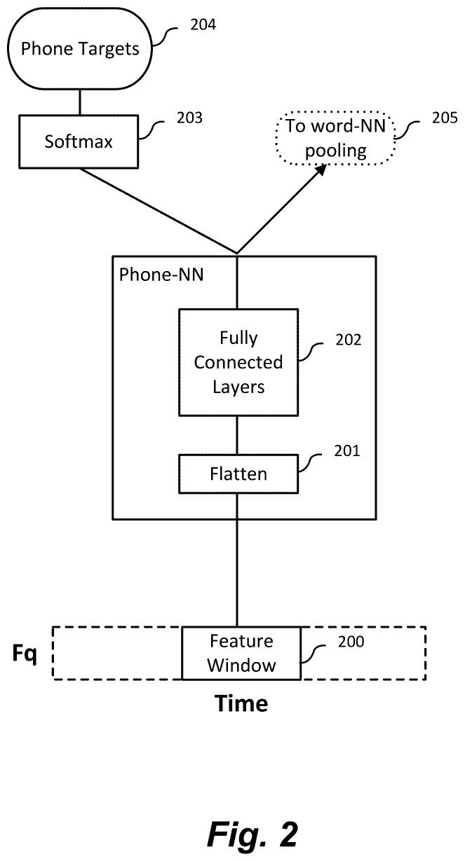

The phone-NN 101 looks at a context large enough to fit a typical phone or tri-phone. In an example implementation, a context of 5 frames to the left or in the past and 5 frames to the right or in the future, for a total context of 11 frames, is provided in the fully connected layers 202 as shown in FIG. 2.

In an example implementation, the phone posteriors 102 are max-pooled along the time axis to reduce the total number of weights to be sent to the next layers 103, reduce calculations, improve training performance, and reduce overfitting. Alternatively, striding along the time axis could be done to achieve the same effect, which is discussed in a later section.

The second set of layers, the word-NN, 103 acts as a keyword classifier. It takes the output of the first set 102 as input and outputs the probability of spotting one of the possible keywords at each point in time. The word-NN 105 is a neural network. In an example implementation, the word-NN 105 contains one fully-connected hidden layer with 64 neurons. The output layer may have one neuron for each keyword to be spotted as well as a neuron for background/filler speech.

The word-NN 103 looks at a context large enough to fit an entire wake word. To reduce latency, a large left context and smaller right context can be used. In an implementation, a size of 115 frames in the past and 5 frames in the future was used. Combined with the context from the phone-NN, this enabled the TDNN to look at a window covering 1215 ms in time.

This window is shifted in time across the input features producing a sequence of posterior probabilities for the wake word detection.

Softmax 104 is utilized to convert the elements of an arbitrary vector into probabilities. A threshold is applied to these probabilities, and keyword detection 107 is triggered when the probability of one of the keywords goes above the threshold. Softmax calculates decimal probabilities to each class in a multi-class problem. Those decimal probabilities must add up to 1.0. This additional constraint helps training converge more quickly than it otherwise would.

### Training Method

In the network architecture shown in FIG. 2, the phone-NN 101 is first trained on a large vocabulary continuous speech recognition (LVCSR) corpus using phone targets 204. Then, the Softmax layer 203 is removed and the remaining layers are connected with the word-NN 105. This is known as transfer learning. The network is then trained using the wake word dataset. When training the full network, the phone-NN 102 weights are updated jointly with the word-NN weights.

Transfer learning is a method for initializing weights by first training the network on a larger corpus for a related task and then using some of the layers of this network to train on the main task. This allows the network to build upon the learning from the larger amount of data of the related task and is particularly useful for scenarios where only a limited amount of data may be available for the main task. Transfer learning and multi-task learning are common practices in keyword spotting because typical keyword spotting tasks have limited amount of data available. This also helps reduce overfitting.

The lower levels of the TDNN, in this case, the phone-NN 101, only looks at small patches of the input data 200. For every incoming patch or speech frame, the phone-NN processes the input using one or more of a fully connected neural network, a convolutional neural network or a recurrent neural network such as 102 in FIG. 1. The output of the network is then flattened, 201 in FIG. 2, and passed to one or more fully connected layers, 202. Recalculating all of these patches whenever the full TDNN is shifted a time step results in a lot of extra computation. The amount of computation can be greatly reduced using caching. The output from the phone-NN 101 patches is cached in a buffer. Then, only the rightmost patch at each level of the TDNN needs to be calculated at each time step.

Preparation of the data is an important step in training the system to work well. In order for the system to work in many different environments, the data used to train should have similar statistical distribution and physical characteristics as data used in the situations where the keyword spotting is to be deployed.

In one training method, the following method of artificially creating data was used.

The data available included:
(a) Short (1-2 second) recordings of the keyword by various speakers of the keyword, for example, “Fluent”
(b) Short recordings of unrelated queries and keywords
(c) Long conversational data that does not contain any examples of the keywords, cut into short sections.

In one implementation, in order to simulate actual use case where the user is performing a voice query, the keyword and command audios are trimmed of silence and stitched together to create long audios in the form keyword+command+pause+keyword+command+pause+etc. However, in another implementation such concatenation of data was not used.

The amplitude of the keywords and commands is randomly varied to simulate audio of different loudness. Furthermore, the resultant audios are then mixed with three kinds of noise, namely street, babble, and music, at an average of 10 dB SNR. In addition, clean data is also used.

In addition to these generated command audios, the long conversation data is added to provide more variation in data. This helps reduce the false alarm rate and is intended to simulate the situation of background chatter to which the system should not respond. Since these conversational audios sometimes already contained background noise or music, no extra noise is added to them.

The exact position of the keyword in the training audio files may be unknown. To resolve this issue, the TDNN is applied during training at different positions in the audio. The audio window which generates the maximum keyword probability is used for gradient backpropagation. This is implemented by using a max pooling layer after the Softmax layer. The max pooling layer is removed before creating the final inference model.

The computation required by the keyword spotting model may be further reduced by skipping frames during inference. Since the region of interest, where the keyword is spoken, spans several frames, it is reasonable to assume that the TDNN output posteriors would only change smoothly between frames. Frame skipping achieves large reductions in computation by taking advantage of this assumption.

In an example implementation, both the phone-NN and word-NN are strided with a step size of 4 input frames, which was chosen after experimentation with different step sizes. As a result, inference is performed every 40 ms.

### On Device Second Stage Keyword Spotting

The description above covers a complete keyword spotting system for one or multiple keywords. However, the accuracy of such systems are often limited because the models have to be small and because limitations of single neural networks. To address these issues, there have been some prior art technologies that have employed multi-stage keyword spotting models. In wakeword related embodiments of these systems, a smaller, less accurate model is used as a first low-power system to detect keywords/wakewords. When the first model detects a wake word candidate, the corresponding audio data, possibly with audio preceding and following the keyword audio is sent to a second, larger and more accurate model. The keyword detection system fires only when both models indicate that the keyword is present. The second model reduces the false alarm rate, while not increasing power requirements substantially since it is only occasionally invoked. In many prior art systems, the second stage model often is used in the cloud. However, as described further below both stages may be run on device. The first stage and the second stage may be performed by the same processor, or a lower powered processor may be used to perform the first stage keyword spotting and a second higher powered processor may be used to perform the second stage keyword spotting.

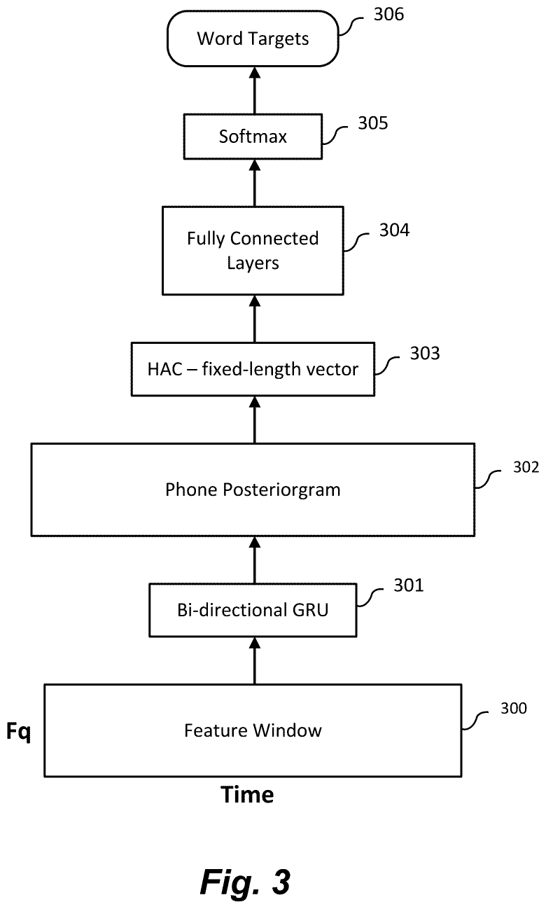

FIG. 3 depicts an on-device second stage keyword spotting system. When the first stage detects a keyword, the speech feature vectors or the audio corresponding to the keyword may be sent to a second neural network on the device for further processing. The second stage model consists of one or more of an acoustic model 301, histogram of acoustic co-occurrences 303 (HAC), and a semantic model 304.

As depicted in FIG. 3, the second stage receives a set of acoustic feature vectors 300, such as FBANK, MFCC, or PLP etc. The feature vectors may be received from the first stage or may be determined by the second stage keyword spotting system. Optionally, such features can also be normalized to have zero mean and unit variance in each frequency bin.

As in the first stage, the acoustic model of the second stage comprises a neural network that outputs a vector at each time step which represents a posterior probability distribution over different phones or phonemes. In an implementation, this is a bidrectional GRU RNN with 3 layers, containing 128 hidden units each 301. Other implementations of this acoustic neural network are possible, such as a fully connected network, a convolutions network, a recurrent network with LSTM units, an auto-encoder network, or a combination thereof. The output of this network is a sequence of phoneme probability vectors also known as a phone posteriorgram 302.

The phone posteriogram is provided to an HAC. One example implementation of HAC is described in F. Gemmeke, Jort. (2014), “The self-taught vocal interface” 21-22. doi: 10.1109/HSCMA.2014.6843243, incorporated herein by reference. It produces a fixed length vector representing the phonetic content of the utterance from the variable length posteriorgram 303. This represents the probability of each pair of phonemes occurring within a given delay of each other. The size of the HAC vector is given by dp² where d is the number of delays used and p is the number of phones. In an implementation, 4 delays are used with 42 phones, resulting in a vector size of 7056. The delays used are 20, 50, 90, and 200 ms.

The semantic model is another neural network or related model that takes a posteriorgram as input and outputs the probability of each keyword being in the given utterance. In an implementation, this is a fully-connected neural network with one hidden layer containing 128 hidden units 304. Other models such as auto-encoder, RNN, CNN, or a combination thereof can also be used. Compressed or sparse models can be used to further reduce the computational footprint.

A Softmax layer 305 is applied to the output of the semantic model to produce a probability of each keyword target 306. A threshold is applied and if one of the keyword probabilities exceeds the threshold, then the system indicates the keyword is detected.

### Experimental Results

The following provides a brief description and results of two experiments: (i) comparison against CNN and (ii) frame skipping. Table 1 provides a summary of each of the models discussed. The second and third columns of the table list the number of parameters and multiplications per second performed during inference for each model. The fourth and fifth columns present the experimentally determined false rejection rates (FRR) for each model on clean and noisy data respectively. All false rejection rates in this section are given for a fixed false alarm rate of 0.5 per hour. In addition, receiver operator characteristic (ROC) curves are plotted for both clean and noisy data.

For each model, the table shows the number of parameters, multiplications per second, and false reject rate in percent on clean data and 10 dB SNR noisy data. FRR values are for a false alarm rate of 0.5 FA/hr.

| | | | FRR- | FRR- |
|---|---|---|---|---|
| Model | Params | Multiplies/s | clean | noisy |
| CNN [Sainath-01] | 95 k | 55.6M | 26.1 | 59.7 |
| TDNN | 173 k | 17.3M | 4.0 | 8.0 |
| TDNN stride = 4 | 173 k | 4.34M | 3.5 | 10.3 |
| TDNN stride = | 1856 k | 4.34M average | 0.9 | 4.4 |
| 4 + second stage | | 86.1M max | | |

The fstride4 CNN keyword spotting system described in Tara N. Sainath and Carolina Parada, “Convolutional neural networks for small-footprint keyword spotting,” Interspeech, 2015, referred to further herein as [Sainath] is used as a baseline. Both the baseline CNN and the current TDNN models are trained on the same data that is described above. However, note that the current dataset is different than the one used in [Sainath]. Furthermore, the amount of training data used in the current experiments is also much smaller than the one used in [Sainath]. Therefore, the performance of the baseline CNN model presented herein differs from that given in [Sainath].

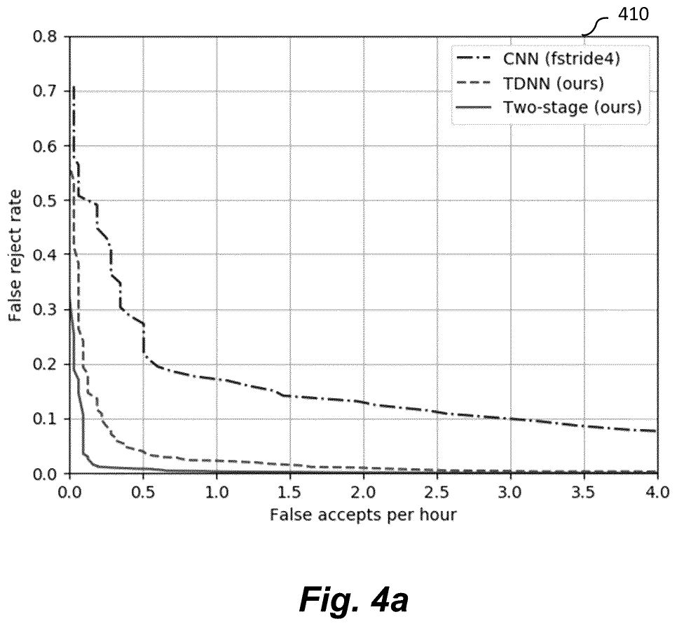

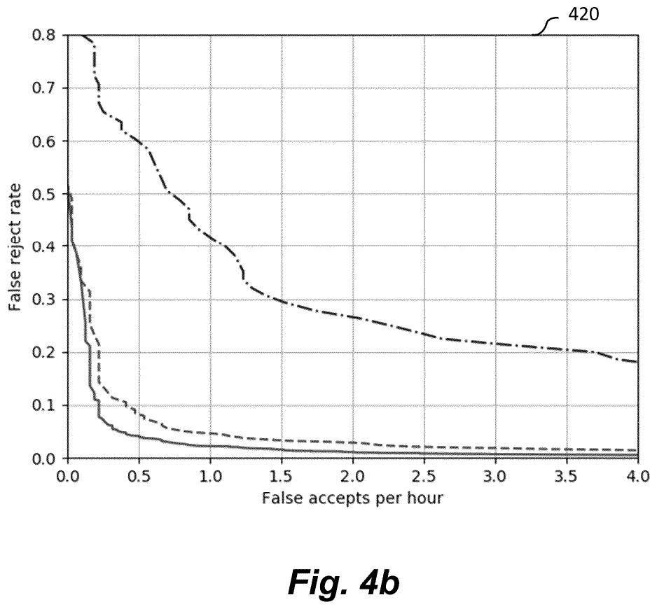

The resulting ROC curves for the baseline CNN, the proposed single-stage TDNN model, and the two-stage model are shown in FIGS. 4a and 4b. FIG. 4a is graph 410 of an experimental ROC curve comparing the disclosed method with related art of [Sainath] on clean data. FIG. 4b is a graph 420 of an experimental ROC curve comparing the disclosed method with related art of [Sainath] on noisy data with an average signal-to-noise ratio (SNR) of 10 dB. As described earlier, the noisy scenario contains data with street, babble and music noise. It can be seen from FIGS. 4a and 4b that compared to the baseline CNN model the TDNN model provides much lower false reject rate for the same false accept rate. Adding a second stage to the TDNN further reduces the false reject rate, at the cost of a larger memory footprint. By comparing the rows corresponding to “CNN” and “TDNN” models in the Table 1, it can be seen that the TDNN network results in an 87% lower false reject rate on noisy data and 84% lower false reject rate on clean data as compared to the CNN model. An advantage of the TDNN architecture presented here is its ability to look at larger windows of inputs than the baseline CNN (1215 ms vs 335 ms) while at the same time reducing the required number of multiplications by 50%. Without wishing to be bound by theory, this might explain the improvement in results.

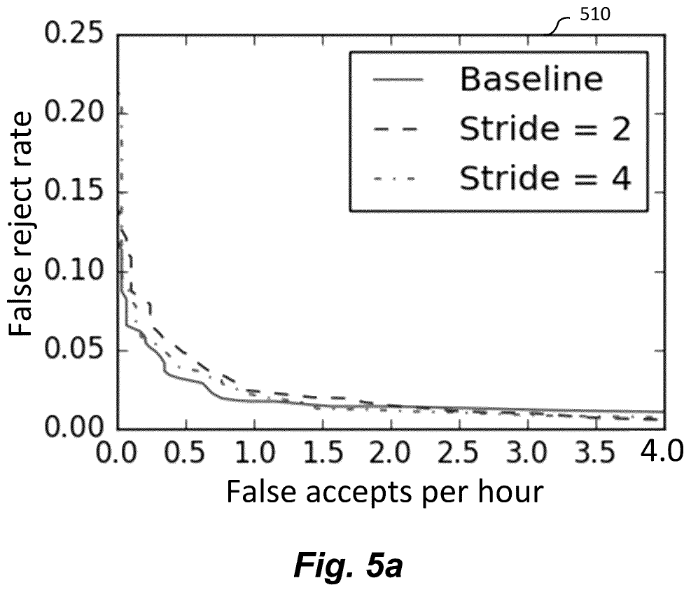

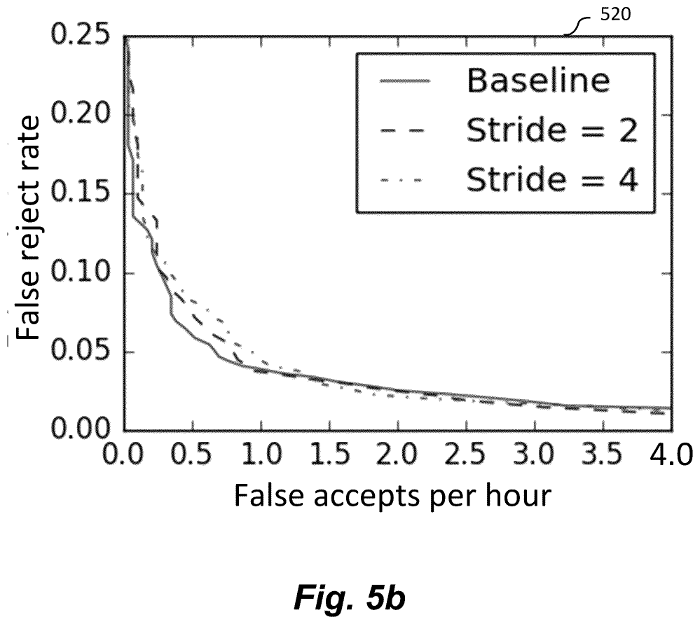

As described earlier, low-powered keyword spotting system may also uses frame-skipping to further reduce the required computation without causing a large drop in accuracy. Experiments were performed on the single-stage model with strides of 4 for both the phone-NN and the word-NN. ROC curves for these experiments are depicted in FIGS. 5a and 5b. FIG. 5a is a graph 510 of an experimental ROC curve showing the effects of frame skipping on clean data. FIG. 5b is a graph 520 of an experimental ROC curve showing the effects of frame skipping on noisy data with an average SNR of 10 dB. It can be seen from the ROC curves that the impact of frame-skipping on accuracy of keyword spotting is very minimal. Resulting FRRs are 8.0% without frame skipping, and 10.3% using a stride of 4. This indicates that frame skipping is a good way to reduce computation without greatly impacting accuracy.

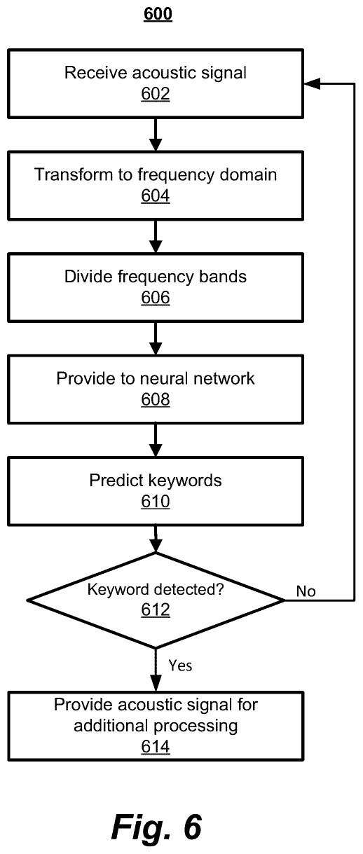

FIG. 6 is a method 600 of low-power keyword spotting which is performed on an electronic device. An acoustic signal comprising speech is obtained (602). The acoustic signal can be provided by a microphone coupled to the electronic device our through a data or audio interface. The acoustic signal is preprocessed by transforming the acoustic signal to a frequency domain representation (604) and dividing the frequency domain representation into a plurality of frequency bands (606). The plurality of frequency bands are provided to a neural network (608), as described in FIG. 1 and FIG. 2, which can process the plurality of frequency bands. At least one of a plurality of keywords or absence of any of the plurality of keywords can then be predicted (610). A time delayed neural network (TDNN) can be used for processing the audio signal which is shifted in time over the input data to produce a sequence of keyword posteriors. Thresholding is used to check if a posterior value for any of the keyword exceeds a certain threshold value. Multiple thresholds can be used for different keywords. In the TDNN one or more sets of layers can be utilized to learn phone and word targets. The first set of layers can be initialized by using transfer learning on a related large vocabulary speech recognition task. If a keyword is detected in the acoustic signal (YES at 612) the signal may be provided to a processor having additional processing capability to verify the keyword and/or perform additional processing on the acoustic signal to process commands with in the acoustic signal (614). The additional processor can utilize a higher power core or processor to verify the keyword before performing additional processor. The primary core/processor may be a low power core/processor which the secondary core/processor will have a higher power requirement. The primary processor/core will wake the secondary core/processor as required to further process the acoustic signal.

A method for reducing the number of multiplications using dynamic programming can be utilized. Alternatively, the total number of multiplications can be reduced by using frame skipping.

A voice activity detection (VAD) system can be used to minimize computation by the TDNN network, where such VAD system only sends audio data to the TDNN when speech is detected in the background. The user query which follows the keyword detection may be recorded for further decoding. Training data can be produced by concatenating recordings of commands and user queries at different volume levels and mixing with different types of noises. Further, unrelated conversational data can be included in training data.

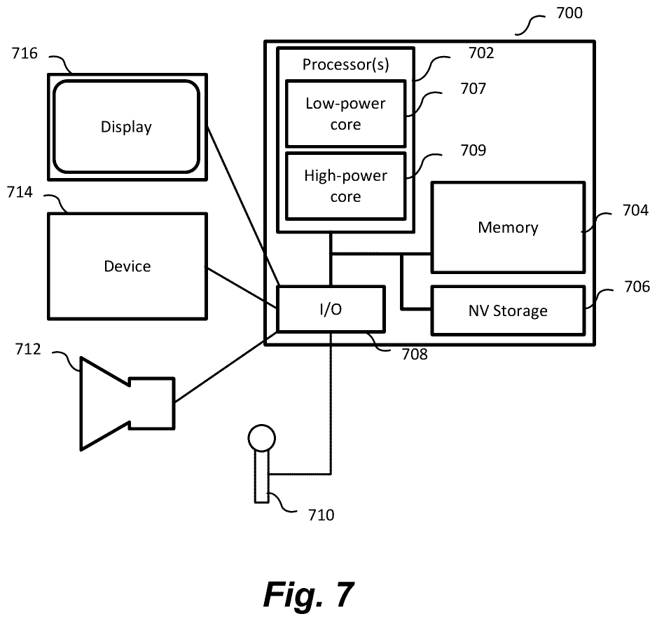

FIG. 7 illustrates a computing device for implementing low-power wakeword spotting system. The system 700 comprises one or more processors 702 for executing instructions that may be stored in non-volatile storage 706 and provided to a memory 704. The processor may be in a computing device or part of a network or cloud-based computing platform. An input/output 708 interface enables acoustic signals comprising speech to be received by a microphone 710. The processor 702 can then process the acoustic signal using the low-powered wakeword spotting described above. Based on the presence or absence of one or more keywords, additional audio processing may occur such as detecting one or more spoken commands, possibly on an associated device 714. Feedback from the low-power wakeword spotting system may generate output on a display 716, provide audible output 712, or generate instructions to another processor or device. The processor 702 may comprise multiple processing cores or utilize separate processors. Some of the cores may be designated for low power processing such as low-power core 707 when the high-power cores are idle 709 or in a power saving state. The low-power core 707 performs initial keyword processing to detect keywords which the remaining part of the phrase received by the device is buffered. If a keyword is detected the low-power processing core 707 can wake up the high-power processing core 709 to perform addition processing of the acoustical signal or verify the wake word that has been detected with a higher accuracy. A low power core may operate at a lower frequency than the high power core or may comprise a lower number of transistors and perform a subset of instructions capably by the higher power core. Alternatively the low-power core may transition to a higher operating frequency or state to operate as the high-power core when a keyword is detected. Although the description processing cores may be single operating units they may comprises multiple cores or functional units for performing desired operations. The simplified processing system allows detection of keyword when the device is in a lower power state efficient and not require the full processing of the acoustic signal to occur by the same processing or to be sent to cloud based processing before performing an action. Dedicated low-power neural network cores present within the processor may be utilized in the lower-power state wherein additional neural network cores may be used to verify the acoustic signal when transitioning out of the low-power state.

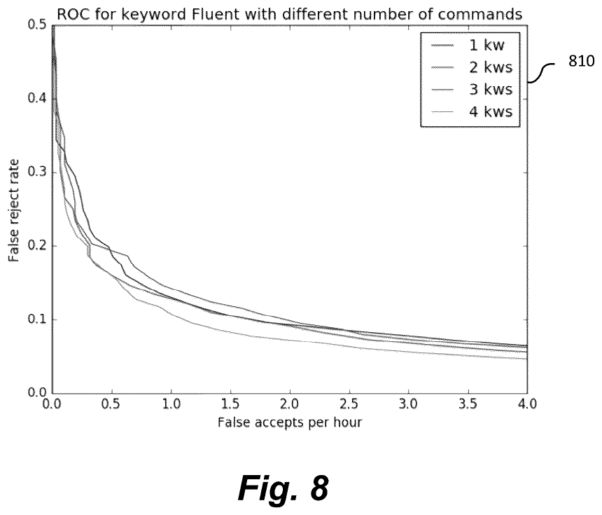

FIG. 8 is a graph 810 of an ROC curve showing performance with multiple command words. As shown the performance of the system is maintained even when multiple keyword or wakeword recognition, for example 2 to 4 words, is desired.

It would be appreciated by one of ordinary skill in the art that the system and components shown in FIGS. 1 to 8 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, Blu-Ray™, a semiconductor ROM, USB, or a magnetic recording medium, for example a hard disk). The program may be in the form of source code, object code, a code intermediate source and object code such as partially compiled form, or in any other form.

What is claimed is:

1. A method for keyword spotting in an electronic device, the method comprising:
obtaining an acoustic signal comprising speech;
performing a first stage keyword spotting by the electronic device comprising:
providing an acoustic signal representation of the acoustic signal to a neural network executed by a processor; and
predicting from the neural network a presence of at least one of a plurality of keywords or absence of any of the plurality of keywords in the acoustic signal, the plurality of keywords comprising a plurality of phones;
performing a second stage keyword spotting by the electronic device to verify the presence of any of the plurality of keywords comprising:
producing a variable length phone posteriorgram comprising a sequence of phoneme probability vectors from the acoustic signal;
producing a fixed-length vector representing the phonetic content of an utterance from the variable length phone posteriogram; and
producing keyword probabilities from the fixed-length vector using a fully-connected network; and
transitioning from a low power processing state to a high power processing state as needed when the presence of any of the plurality of keywords in the acoustics signal are detected for any additional processing.

2. The method of claim 1, wherein the acoustic signal representation comprises a feature domain representation obtained by preprocessing the acoustic signal or the acoustic signal representation is a waveform representation.

3. The method of claim 1, wherein the acoustic signal representation is a waveform representation.

4. The method of claim 1, wherein the neural network is a time delayed neural network (TDNN) that produces a sequence of keyword posteriors.

5. The method of claim 1, wherein predicting the presence or absence of keywords comprises determining if a posterior value for any of the plurality of keywords exceeds a threshold value, and if the posterior value of a respective keyword exceeds the threshold value predicting the presence of the respective keyword in the audio signal.

6. The method of claim 1, wherein a plurality of different threshold values are used for the plurality of keywords.

7. The method of claim 6, wherein the TDNN uses one or more sets of layers to learn phone and keyword targets.

8. The method of claim 1, wherein a first set of layers is initialized by using transfer learning on a related large vocabulary speech recognition task.

9. The method of claim 1, further comprising reducing a number of multiplications per second performed during inference of a model of the neural network using dynamic programming.

10. The method of claim 1 wherein a total number of multiplications per second performed during inference of a model of the neural network is reduced by frame skipping.

11. The method of any of claim 1, wherein a voice activity detection (VAD) system is used to minimize computation by the TDNN network, wherein the VAD system only sends the audio signal representation to the TDNN when speech is detected in the background.

12. The method of claim 1, further comprising recording a user query following keyword detection and recording it for further decoding wherein start and end times of the keyword are found in the acoustic signal.

13. The method of claim 1, wherein a second neural network is used for second stage decoding, comprising of one or more of:
a bidirectional GRU RNN model to produce a phone posteriorgram;
a histogram of acoustic correlations (HAC) to produce a fixed-length vector from the phone posteriorgram; and
a fully-connected network to produce keyword probabilities from the fixed-length vector.

14. The method of claim 1, wherein training data for the neural network is produced by concatenating recordings of commands and user queries at different volume levels and mixing with different noise types.

15. The method of claim 1 wherein upon predicting from the neural network the presence of at least one of the plurality of keywords in the acoustic signal in a low power state by a first lower power processing core, the high power state of a second high power processing core is awoken from a sleep state to perform further processing on the acoustic signal.

16. The method of claim 1 where in the second processing core verifies the presence of at least one of the plurality of keywords in the acoustic before performing further processing of the acoustic signal to determine one or more commands within the acoustic signal.

17. A system for providing low power keyword spotting, the system comprising:
a microphone;
a memory storing instructions; and
a processor coupled to the microphone and memory, the processor executing the instructions, which when executed configure the system to:
obtain acoustic signal comprising speech;
perform a first stage keyword spotting by the electronic device comprising:
providing an acoustic signal representation of the acoustic signal to a neural network; and
predicting from the neural network a presence of at least one of a plurality of keywords or absence of any of the plurality of keywords in the acoustic signal, the plurality of keywords comprising a plurality of phones;
perform a second stage keyword spotting by the electronic device to verify the presence of any of the plurality of keywords comprising:
producing a variable length phone posteriorgram comprising a sequence of phoneme probability vectors from the acoustic signal;
producing a fixed-length vector representing the phonetic content of an utterance from the variable length phone posteriogram; and
producing keyword probabilities from the fixed-length vector using a fully-connected network; and
transitioning from a low power processing state to a high power processing state as needed when the presence of any of the plurality of keywords in the acoustics signal are detected for any additional processing.

18. The system of claim 17, wherein the acoustic signal representation comprises a feature domain representation obtained by preprocessing the acoustic signal or the acoustic signal representation is a waveform representation.

19. The system of claim 18, wherein the neural network is a time delayed neural network (TDNN) that produces a sequence of keyword posteriors.

20. The system of claim 17, wherein predicting the presence or absence of keywords comprises determining if a posterior value for any of the plurality of keywords exceeds a threshold value, and if the posterior value of a respective keyword exceeds the threshold value predicting the presence of the respective keyword in the acoustic signal.

21. The system of claim 17 wherein the processor further comprises a first core and a second core, wherein the first core is a low-power processing core and the second core is a high-power processing core, when the first core in the low power processing state determines the presence of at least one of the plurality of keywords in the acoustic signal the acoustic signal is provided to the second core in a high power processing state for further processing.

22. The system of claim 17 wherein a processing core of the processor operates in a lower power processing state until the presence of at least one of a plurality of keywords in the acoustic signal the acoustic signal and transitions to a high power processing state for performing further processing of the acoustic signal.
